(19) United States
(12) Patent Application Publication
(10) Pub. No.: US 2016/0050612 A1
(43) Pub. Date: Feb. 18, 2016

(54) AGGREGATION-NODE SELECTION USING VIRTUAL HUB

(71) Applicant: TELEFONAKTIEBOLAGET L M ERICSSON (PUBL), Stockholm (SE)

(72) Inventors: Johan AXNÄS, Solna (SE); Kumar BALACHANDRAN, Pleasanton, CA (US); Dennis HUI, Sunnyvale, CA (US)

(73) Assignee: Telefonaktiebolaget L.M. Ericsson (publ)

(21) Appl. No.: 14/779,110

(22) PCT Filed: Mar. 27, 2013
(86) PCT No.: PCT/SE2013/050343

§ 371 Date: Sep. 22, 2015

(51) Int. Cl. H04W 40/04; H04L 12/721; H04W 72/04

(52) U.S. Cl. CPC H04W 40/04; H04W 72/04; H04L 45/123

(57) ABSTRACT

A route determination method is provided in a multi-hop network having a number of nodes, where at least two nodes are target nodes. The multi-hop network includes a fictitious node having fictitious links to at least two of the target nodes. The method includes determining, at least part of one or more extended routes for connecting one or more of the nodes included in the multi-hop network, to the fictitious node and determining, at least a part of a route in the multi-hop network, using the at least part of one or more extended routes. Other methods and devices are disclosed for route determination in a multi-hop network have several gateways or aggregation nodes for connecting to a communication network, and for routing in a multi-hop network.

### TECHNICAL FIELD

The proposed technology generally relates to route determination and routing in a multi-hop network. One aspect of the proposed technology relates to a method and device for route determination in a multi-hop network having several gateways or aggregation nodes for connecting to a communication network, a method and device for routing in a multi-hop network as well as a corresponding device and computer program. The proposed technology also relates to an aggregation node and to a method in an aggregation node.

### BACKGROUND

In a typical cellular radio system, wireless devices (also known as mobile stations and/or user equipments (UEs)) communicate via a radio access network (RAN) to one or more core networks. The radio access network (RAN) covers a geographical area which is divided into cell areas, with each cell area being served by a base station or wireless access nodes, e.g., a radio base station (RBS), which in some networks may also be called, for example, a “NodeB” (UMTS) or “eNodeB” (LTE). A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units (UE) within range of the base stations.

To cope with the exponential growth in wireless data traffic, it is anticipated that substantially denser deployment of base stations or wireless access nodes will be required in the future. The feasibility of a very dense deployment of wireless access nodes is dependent on the existence of a backhaul network that can provide high-data-rate transport for each individual access node in the network. In a hierarchical telecommunications network the backhaul comprises the intermediate links between the core network, or backbone network and the radio access network. From the point of view of maximizing capacity, optical-fiber-based backhaul solutions are probably the most desirable ones and are most suitable for new constructions. However, in existing buildings and infrastructure, the cost of installation of new fibers to every access node in a very dense network can be prohibitive.

An alternative to the fiber backhaul solution is the wireless self-backhaul solution, where the same access spectrum is used to provide transport. With self-backhauling, an access node may serve not only its own assigned user equipments (UEs) in its vicinity but also its neighboring access nodes as a relaying node in order to route data towards and/or from an information aggregation node, i.e. a node with a link to a fixed, typically wired, network such as the Internet and/or intra-net.

Aggregation nodes are, depending on context, alternatively referred to using other terms, e.g. egress nodes, ingress nodes, mesh portal points, or gateways. A group of self-backhauling access nodes can form a multi-hop network, where communication between two end nodes is carried out through a number of access nodes whose function is to relay information from one point to another. FIG. 1 illustrates user equipments (UE) 40 connecting to a communication network 2, comprising a number of access nodes 11, using a wireless backhaul 10. The wireless backhaul comprises a number of wireless access nodes, 11, forming a multi-hop network and one aggregation node 12 comprising a link to the communication network. Hence, the access nodes, 11, cooperatively route each other's traffic to and from the aggregation node, 12, where traffic is transmitted further to the communication network 2.

We here assume that data is typically to be transmitted between a UE in the wireless network and a node outside the wireless network. In case two UEs in the same wireless network need to communicate, their data is typically routed via a server outside the wireless network. The determination of the best routes to and from the aggregation node is a difficult problem that is in general NP-hard and hence cannot be solved optimally. Finding good suboptimal routing algorithms is an active research area.

In general, there may be multiple aggregation nodes. FIG. 2 illustrates a wireless backhaul comprising two aggregation nodes 12a, 12b. When having two aggregation nodes it is necessary to decide for each UE in the network, which aggregation node, 12a, 12b, it should optimally be connected to in order to have the overall best routing solution for the network.

When certain conditions are fulfilled, the task of finding the optimal aggregation node to which a UE should be connected can be straightforwardly solved using well-known routing algorithms such as the Bellman-Ford algorithm or the Dijkstra algorithm.

Bellman-Ford algorithm and the Dijkstra algorithm find the shortest path or route, in the sense of yielding the smallest path metric, among all possible paths from a source node to every other node in a network, wherein the path metric represents the quantity to be optimized. Both algorithms utilize the isotonicity and monotonicity properties to reduce the original path-search problem into smaller sub-problems via dynamic programming.

The Dijkstra algorithm operates by finding the next closest node to the source node one at a time. It exploits the fact that the shortest path of the next closest node to the source node must be a neighbor node of one of the currently known closest nodes from the source node. The algorithm therefore maintains two sets of nodes, namely a known set (of closest nodes) and a candidate set, during its operation. It iteratively finds the next closest node to the source node from the candidate set and adds it to the known set. The candidate set is then updated by the neighbor nodes of the added node. The Dijkstra algorithm efficiently identifies the best route to the source node for each node in the network when the knowledge of the global topology is available. The Dijkstra algorithm is adopted by most of the so-called “link-state-based” routing protocols.

The Bellman-Ford algorithm operates by having each node in the network iteratively informing its neighboring nodes its best achievable path metric to reach a destination node so that at each iteration, each node can be made aware of 1) which neighbor node is the best node to forward information towards the destination node, and 2) the associated best path metric, for a given maximum number of hops to reach the destination node. Since each node only needs to be aware of the local topology (e.g. the set of neighbor nodes) the algorithm can be implemented in a decentralized fashion with each node sharing some of the computations in parallel. However, when implemented in a centralized manner, the algorithm is typically more computationally demanding than the Dijkstra algorithm. The Bellman-Ford algorithm is adopted by most of the so-called “distance-vector-based” routing protocols.

For example, if there is only a single UE in the network, and the routing solution only needs to optimize one single performance measure (e.g. only bit rate, or only latency, or only energy consumption), and there is no significant interference between the wireless links, and there is no resource allocation decisions (e.g. frequency slot allocation decisions) to take for the links of a route, then the Bellman-Ford and Dijkstra algorithms are directly applicable. Note that additionally, the performance measure may need to fulfill certain mathematical requirement.

A more generally applicable approach, described e.g. in US patent publication US2011987815A, consists in finding routes from each UE to all aggregation nodes and let the UE transmit all packets to all aggregation nodes over these routes. Each such route then has a well-defined source and destination node, as required by many existing routing algorithms. In order to prevent a packet from being sent multiple times to the end receiver, the aggregation nodes would communicate with each other (e.g. via a wire) to select for each packet only one of the aggregation nodes that should forward the packet further over the wired network.

However, all the above approaches have major drawbacks. In practice, at least one of the conditions needed to make direct use of the Bellman-Ford or the Dijkstra algorithms does not hold. For example, there may be multiple UEs in the network, or more than one performance measure needs to be considered (e.g. both bit rate and latency), or interference between wireless links is significant.

Letting each UE send each packet to all aggregation nodes also has several drawbacks, one being the excessive use of radio resources. For example, it is likely that the different routes from a UE to the different aggregation nodes may interfere with each other to some extent, implying that each of the routes, including the route to the aggregation nodes ultimately forwarding the packet, will have a lower bit rate than if only one of the routes had been used.

### SUMMARY

The present disclosure proposes a general method for routing when there are multiple target nodes. The core idea of the presented technique is to introduce, as a conceptual and computational tool, a fictitious node.

According to one aspect of the disclosure, it provides for a method for route determination in a multi-hop network comprising a number of nodes, whereof at least two nodes are target nodes. The method comprises the steps of: including, in the multi-hop network, a fictitious node, the fictitious node being defined to have fictitious links to at least two of the target nodes, determining, at least part of one or more extended routes for connecting one or more of the nodes comprised in the multi-hop network, to the fictitious node and determining at least a part of a route in the multi-hop network, using the at least part of one or more extended routes.

The proposed technique enables, through the introduction of the fictitious node, re-using, in a situation with multiple aggregation nodes, any existing routing algorithm designed for the case of only a single aggregation node. Thereby, performance for networks with multiple aggregation nodes is improved.

According to one aspect of the disclosure, the target nodes are aggregation nodes, each aggregation node having a link to a communication network. The proposed technique then facilitates route determination and aggregation node selection for a node in the meshed network that wants to connect to the communication network.

According to one aspect of the disclosure, the step of defining the fictitious node comprises updating neighbor lists of the target nodes, to which the fictitious node is defined to be connected, with an identity of the fictitious node. By these actions a fictitious node is easily inserted in the multi-hop network.

According to one aspect of the disclosure, it relates to a computer program comprising computer program code which, when executed in a node in a multi-hop network, causes the node to execute the method described above.

According to one aspect of the disclosure, it relates to device for route determination in a multi-hop network, comprising at least two target nodes. The device comprises 1) an includer configured to define, in the multi-hop network, a fictitious node, the fictitious node being defined to have connections to at least two of the target nodes, 2) an extended route determiner, configured to determine at least part of one or more extended routes for connecting one or more of the nodes comprised in the multi-hop to the fictitious node, and a 3) route determiner configured to use the at least part of one or more extended route for route determination in the multi-hop network.

According to one aspect of the disclosure, it relates to a method in an aggregation node, the aggregation node attaching a multi-hop network comprising a number of nodes to a communication network, comprising the following steps of updating a neighbor list of the aggregation node with the identity of a fictitious node, said neighbor list defining nodes to which the aggregation node is connected by direct links.

According to one aspect of the disclosure, it relates to an aggregation node, for attaching a multi-hop network comprising a number of nodes to a communication network, comprising: a link to the communication network; a communication interface configured for wireless communication with the nodes in the multi-hop network; a memory configured to store a neighbor list defining the nodes in the multi-hop network, to which the aggregation node is attached; and processing circuitry, configured to update a neighbor list of the aggregation node with a fictitious node.

With the above description in mind, the object of the present disclosure is to overcome at least some of the disadvantages of known technology as previously described.

### BRIEF DESCRIPTION OF THE DRAWINGS

The present technique will be more readily understood through the study of the following detailed description of the embodiments/aspects together with the accompanying drawings, of which:

FIG. 1 illustrates a wireless backhaul.

FIG. 2 illustrates a wireless backhaul comprising two aggregation points.

FIG. 3 illustrates including a fictitious node in a wireless backhaul comprising two aggregation points.

FIG. 4a is an Illustration of a network represented by a directed graph.

FIG. 4b is an Illustration of a graph representing a network with multiple aggregation nodes and a virtual hub.

FIG. 5 is a flow chart illustrating a method for route determination according to an exemplary embodiment of the present disclosure.

FIG. 6 illustrates in a graph, an extended route between a node and a fictitious node.

FIG. 7a is a schematic diagram illustrating a node comprising a device for route determination.

FIG. 7b is a schematic diagram illustrating an aggregation node.

FIGS. 8a and 8b are flow charts illustrating a respective method in an aggregation node.

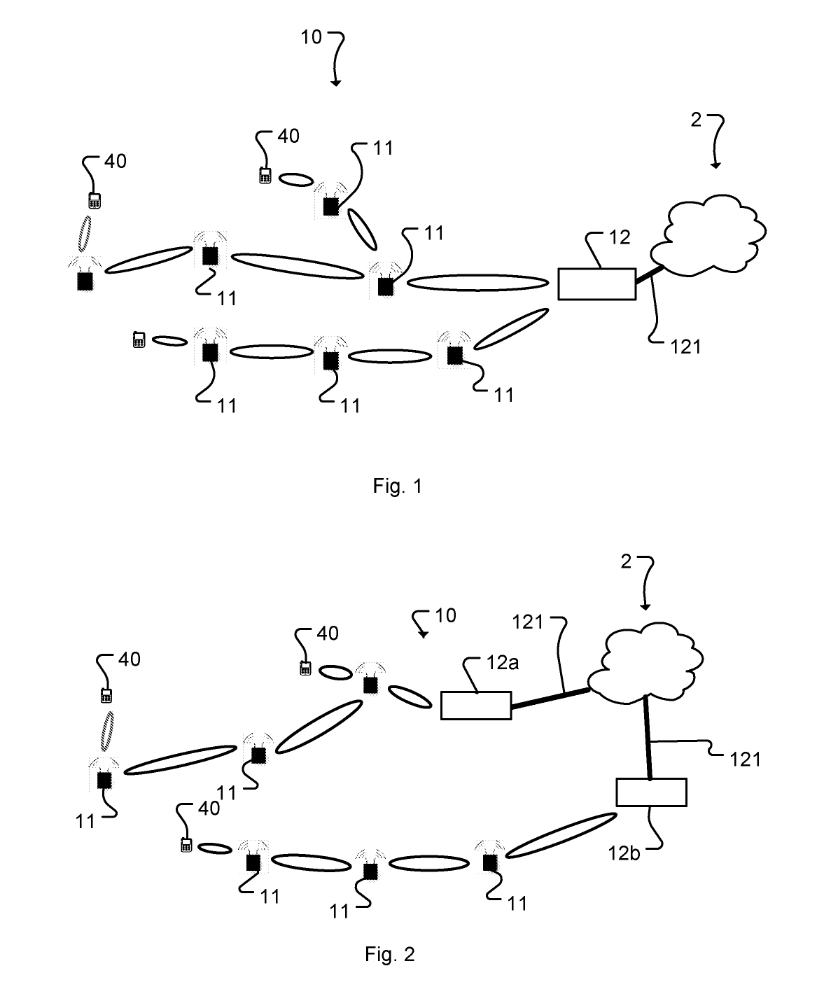

It should be added that the following description of the embodiments is for illustration purposes only and should not be interpreted as limiting the disclosure exclusively to these embodiments/aspects.

### DETAILED DESCRIPTION

The general object or idea of embodiments of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

Embodiments of the present disclosure relate, in general, to the field of wireless backhauling. According to one aspect of this disclosure, the multi-hop network is a wireless backhaul and the at least one node is at least one wireless mobile entity or access point that is to be connected to the communication network. However, it must be understood that the same principle is applicable in any multi-hop network, where one or several routes from one or more source nodes to several target nodes is to be computed.

A multi-hop network in this application is defined as a network where communication between two end nodes is carried out through a number of access nodes whose function is to relay information from one point to another. Communication in a multi-hop network is often wireless and the access nodes may be mobile as well as fixed. In some multi-hop networks the nodes form a meshed network, generally referred to as a wireless meshed multi-hop network. Other terms used for describing what we refer to as a multi-hop network are, depending on the application, e.g. an ad hoc network or a meshed network.

In general, routing can be defined as the act of moving information from a source node to a destination node via one or more intermediate nodes in a communication network. In a multi-hop network, nodes out of reach from each other may benefit from intermediately located nodes that can forward their messages from the source towards the destination.

Routing generally involves two basic tasks: determining suitable routing paths and transporting information through the network. In the context of the routing process, the first of these tasks is normally referred to as route determination and the latter of these tasks is often referred to as packet forwarding.

A route connects two nodes in a network. In a multi-hop network a route comprises a sequence of links and nodes. The route is defined by the properties of the links such as bit-rate or latency. The route may as well be affected by the properties of the nodes.

The proposed technology is generally applicable to any routing protocol, independent of implementation, including both distributed and centralized routing algorithms, hop-by-hop routing as well as source-routing, link-state routing and distance-vector routing, proactive or reactive routing, flat or hierarchical routing, single path and multi-path routing, as well as variations and combinations thereof.

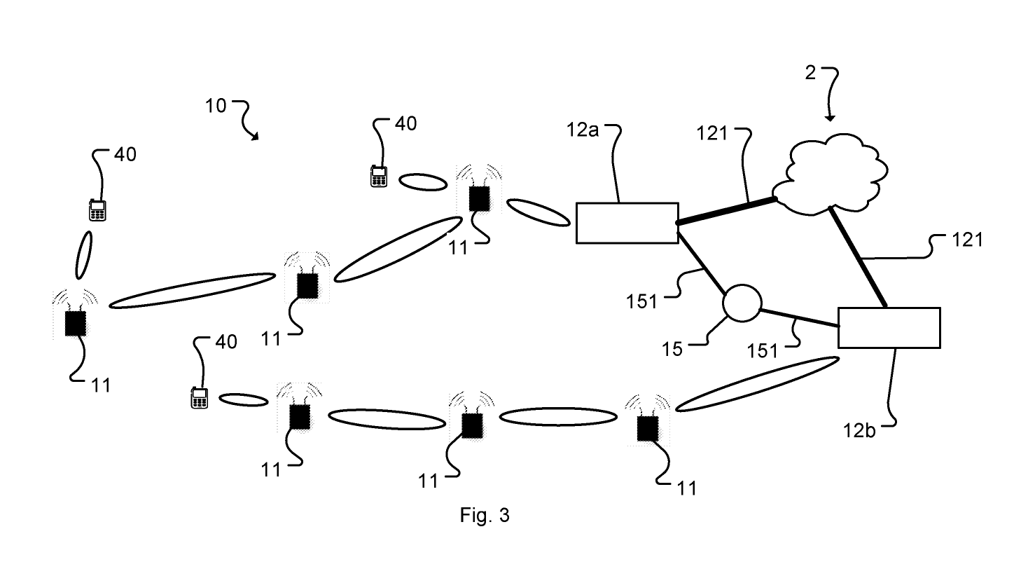

The core idea of the presented technique is to introduce, as a conceptual and computational tool, a fictitious node, henceforth referred to as a virtual/fictitious hub or node. FIG. 3 illustrates insertion of a fictitious node, 15, in the multi-hop network of FIG. 2. The fictitious node, 15, is assumed (defined) to have perfect links (i.e. infinite-capacity, zero-latency, zero-energy-consuming links) to all target nodes, 12, or at least links that have less latency and higher capacity than any link in the multi hop network. The router then searches for the best path, i.e. a path which is optimal considering one or several predefined criteria, between respective UE and the virtual hub.

An aggregation node in this application is defined to be a gateway having a direct connection to a communication network, such as a core network or the internet. The direct connection is either a wired connection or a wireless link.

Since this is an example of a routing problem where each route to be found has a single well-defined source 40 and a single well-defined destination node 15, any existing routing algorithms designed for such a situation can be directly applied. In particular, advanced algorithm that considers aspects such as interference management, multiple metrics, and/or multiple simultaneous routes may be directly applied. It is easy to see that each route so found must pass through one of the aggregation nodes, 12, which is then the optimal aggregation node for the respective UE to connect to, which will be proven more formally below. Note that since the virtual hub is a fictitious node serving primarily as a tool for routing, it does not necessarily have to reside in any unique physical location. Several generalizations of this technique are possible and will be described further on.

In this application the term User Equipment, UE, or wireless device is generally used. A wireless device, or User Equipment, UE, which is the term used in the 3GPP specifications, referred to in this application could be any wireless device capable of communicating with a wireless network. Examples of such devices are of course mobile phones, Smartphones, laptops and Machine Type Communication, MTC, devices etc. However, one must appreciate that capability to communicate with a wireless network could be built into a variety of environments such as within a car or on a lamppost or into devices such as home appliances, process control equipment or as part of large scale networks such as an Intelligent Transportation System, ITS, etc.

### Graph Representation

Graph representation of a multi-hop network will now be introduced in order to fully explain the principle of the presented technique.

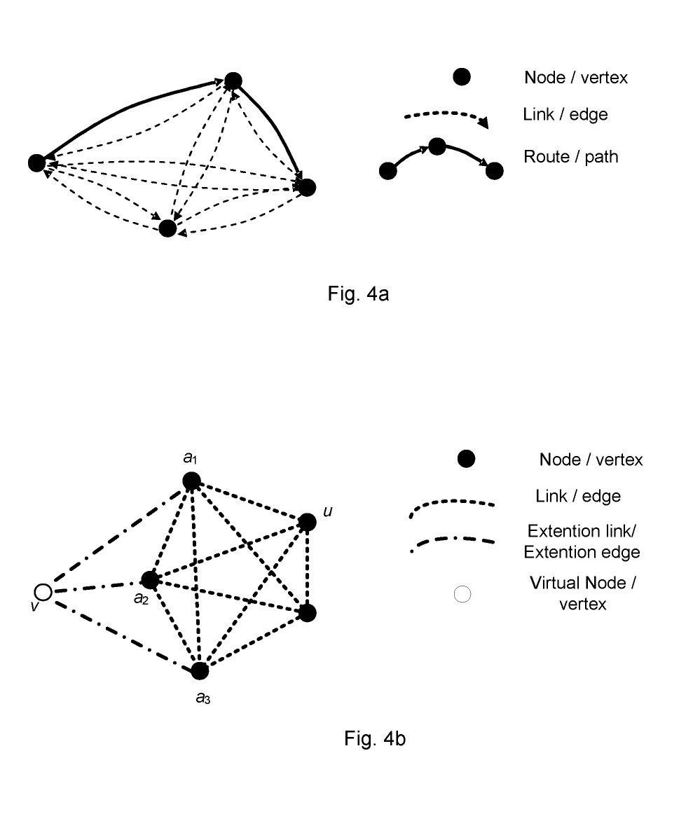

A multi-hop network can be modeled mathematically as a connected graph, as shown in FIG. 4a, also referred to as a directed graph, in which each node is represented by a graph vertex, and each (potential) wireless link (hop) in the network is represented by a graph edge, illustrated by a dashed line in FIG. 4a.

More precisely, let G≡(V, E) denote such a directed graph, as illustrated in FIG. 4a, where V denotes the set of (graph) vertices, and E denotes the set of (graph) edges, each connecting two vertices in V. Each network node is here represented by a vertex vεV, and each (potential) wireless link (hop) between two distinct nodes is represented by an edge eεE. An edge e can be represented by an ordered pair e (v′ v′), where v and v′ must be in V. Two vertices are said to be adjacent to each other if they are connected by an edge. Network nodes represented by adjacent vertices are neighbor nodes of one another. The list of all neighbor nodes of a given node is referred to as its neighbor list. This representation essentially captures the topological structure characterized by the inter-node connectivity within the network.

In the multi-hop network, a route connects a source node (e.g. aggregation point of the backhaul network) to a destination node (e.g. a UE or a distant access node. A route can be represented by a path P in the graph, which is an alternating sequence of vertices and edges v₁, (v₁, v₂), v₂, (v₂, v₃), v₃, . . . , vᵢ, (vᵢ, vᵢ₊₁), vᵢ₊₁, . . . , v_{K}, where vᵢ εV for all i=1, 2, . . . , K and (vᵢ, vᵢ₊₁)εE for all i=1, 2, . . . , K−1, and where K−1 is the number of edges on the path P, v₁ is the start vertex, typically representing a source node of a route in the wireless network, and v_{K} is the end vertex, typically representing a destination node. For any given path P, define V(P) as the set of all vertices {vᵢ}ᵢ₋₁^{K} on the path P, and define E(P) as the set of all edges {(vᵢ, vᵢ₊₁)}ᵢ₌₁^{K-1} on the path P. Note that since the vertices of a valid edge in E must be in V, a path may be simply represented by a sequence of edges in E It must likewise be noted that a canonical representation of the path can be declaimed by the sequence of vertices alone, since any consecutive pair of vertices forms an edge. The characterization of a path by an alternating sequence of vertices and edges is useful in a more general setting when the set of vertices V and the set of edges E are defined as independent mathematical objects. However, this is outside the scope of graph-theoretic terminologies required in this patent application.

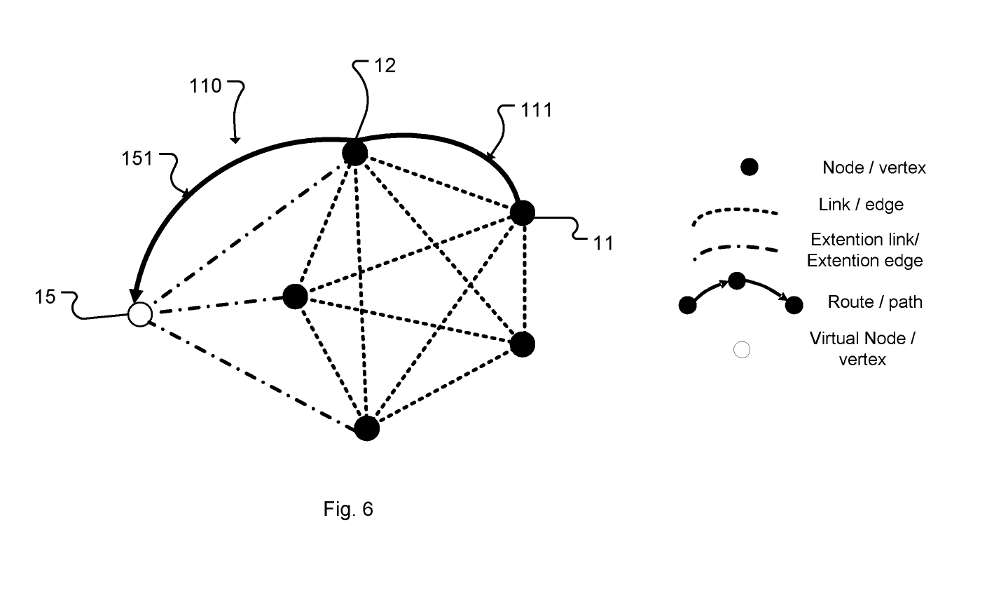

In this application, the terms relating to the real network (e.g. node, link, and route) and the corresponding terms relating to the graph representation (e.g. vertex, edge and path) will be used more or less interchangeably. Furthermore, in the following examples “link” as well as “edge” is sometimes used to denote, what in reality are two links/edges, one in each direction. For example, the links/edges in FIGS. 4b and 6 represent bi-direction connections. Hence, for simplicity in this application, the term “link” in this respect, sometimes means link in a more general everyday sense.

Centralized Vs. Distributed Routing

Routing, in a multi-hop network, can be centralized or distributed (de-centralized). In a centralized solution, all routing decisions are taken by a single node (e.g. an aggregation node) that is assumed to have access to all relevant (or at least sufficient) information about all relevant (or a sufficient subset of) nodes and links in the network. In a distributed solution, routing decisions are taken locally based on information only (or primarily) from neighboring nodes. Both types of routing have their respective advantages and disadvantages.

To simplify for the reader, the algorithm descriptions in this report primarily take a centralized perspective, but it should be obvious to the person skilled in the art that the ideas are applicable also to the distributed case.

Routing (centralized or distributed) typically requires three steps: (i) collecting relevant information about the quality of potential links and/or paths, (ii) selecting a path (or part of path) based on the collected information, and (iii) communicating information about the selected path to the relevant nodes.

Single Vs. Multiple Routes

In general, source and destination nodes could be simultaneously connected by multiple different routes through the network. This could, in principle, increase the maximum achievable throughput and improve the robustness to network congestion and the resilience to node failure. This description focuses on the case of one route per source-destination pair, but the presented technique can be applied also to cases where multiple routes per source-destination node pair are allowed.

### Single Route Determination

The present technique will now be described in further detail referring to FIG. 4b using graph representation as defined above. Firstly, the case where there is only one node u that is to be connected to an aggregation node is considered. Denote the aggregation nodes as a₁, a₂, . . . , a_{M}, where M is the number of aggregation nodes in the network. Then define an extended graph G^{(ext)}(V^{(ext)}·E^{(ext)}) through

V^{(ext)}=V∪v, (1)

E^{(ext)}=E∪{(v,a₁),(a₁,v),(v,a₂),(a₂,v), . . . ,(v,a_{M}),(a_{M},v)} (2)

where v is a virtual/fictitious hub or node. Further, for any path P having as start vertex an aggregation node aₘ, define a corresponding extended path

P^{(ext)}=(v,aₘ)⊕P, (3)

and for any path P having as end vertex an aggregation node aₘ, define a corresponding extended path

P^{(ext)}=P⊕(aₘ,v). (4)

An extended graph is illustrated in 4b, where the extended paths are illustrated by dash-dotted lines.

From this definition also follows immediately that given an extended path P^{(ext)}, the corresponding non-extended path P can be easily obtained as

P=P^{(ext)}\(v,aₘ) (5)

Or

P=P^{(ext)}\(v,aₘ), (6)

respectively, where \ here denotes removal of a link with the real starting vertex aₘ that has been connected to the fictitious starting node v. There is an obvious formulation corresponding to the action of Equation (4). Further define the path metric of any extended path P^{(ext)} as

μ(P^{(ext)})≡μ(P) (7)

In the special case of additive metric, one may alternatively and equivalently define

μ((aₘ,v))=μ((v,aₘ))=0 (8)

as a more natural extension of the additive metric. Eq. (7) then follows from (3),(4), and the definition of additive metric. Similar alternative equivalent definitions are possible also with many other types of metrics, e.g. for minimum/bottleneck metrics.

The extended graph includes both all links and nodes, whereas the original non-extended graph includes only the solid-line links and black nodes. To keep the figure simple, only one line is used to represent both link directions between each pair of nodes.

It is now shown, how the above concepts of extended network and extended paths can be used to solve the optimal-routing problem in the original network. More specifically, it is shown that if an extended route P^{(ext)} is found to be the optimal route connecting a node u with the virtual hub (in the extended graph), then the corresponding non-extended route P is the optimal route for connecting node u with an aggregation node (in the original, non-extended graph). Note that a route P^{(ext)} being optimal in this sense is equivalent to the relation

μ(P^{(ext)})≦μ(R^{(ext)}) (9)

holding for any extended route R^{(ext)}. Similarly, a route P being optimal in the above-mentioned sense is equivalent to the relation

μ(P)≦μ(R) (10)

holding for any non-extended route R. But (10) follows from (9) and the definition (7), hence showing that if P^{(ext)} is optimal in the above-mentioned sense, then P is optimal in the above-mentioned sense. In other words, by finding the optimal route P^{(ext)} using any existing routing algorithm for routing between a single well-defined source node and a single well-defined destination node, the optimal route P for connecting u with the optimal aggregation node is obtained from (5)(if the virtual node is the start of P^{(ext)}) or (6) (if the virtual node is the end of P^{(ext)}).

Hence, the proposed technique enables re-using, in a situation with multiple aggregation nodes, any existing routing algorithm designed for the case of only a single aggregation node, thereby enabling improved performance for networks with multiple aggregation nodes.

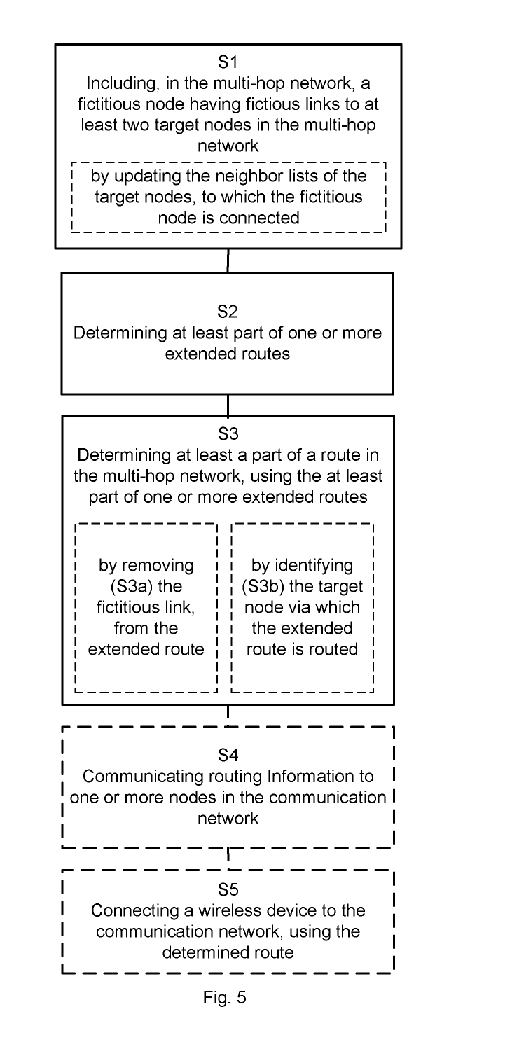

The method described above is summarized as a flow chart in FIG. 5 disclosing a method for route determination in a multi-hop network 10 comprising a number of nodes, 11, 12, whereof at least two nodes are target nodes, 12. A route in this application refers to a sequence of links and nodes that can be used for sending data between two nodes in the multi-hop network. There are typically several different routes connecting two nodes in the multi-hop network. A target node here refers to a target node within the destination network. The target may be an aggregation node or gateway e.g. to another network. Hence, the target node is not necessarily the destination node, i.e. the final destination of a packet.

According to one aspect of this disclosure, the target nodes are aggregation nodes, 12, having a link to a communication network. The presented technique can also be applied more generally to the search for the best path with the smallest metric (or, simply, the shortest path) between any two disjoint sets of nodes in a network. Let G=(V, E) denote the directed graph of a network, and let A and B be two disjoint subsets of the vertex set V. The best path (or the shortest path) P from node set A to node set B is the path with the minimum metric among all paths with start vertex in A and with end vertex in B. Such a best path can be obtained by introducing a fictitious node v_{A} for node set A, a fictitious node v_{B} for node set B, and a corresponding extended graph

V^{(ext)}=V∪v_{A}∪v_{B}, (11)

$${E}^{( ext )} - E ⋃ {⋃}_{a ∈ A} \{ ( a , {v}_{A} ) \} ⋃ {⋃}_{a ∈ B} \{ ( {v}_{B} , b ) \} \qquad ( 12 )$$

A conventional routing algorithm can then be run on the extended graph G^{(ext)}=(V^{(ext)}, E^{(ext)}) to find the best extended path P^{(ext)} from which the best path P from node set A to node set B can be obtained. Obviously, if set A (or set B) contains only a single node, it is not necessary to introduce the virtual hub v_{A} (or respectively v_{B}). For routing to multiple aggregation nodes, node set B may represent the set of all aggregation nodes while node set A may represent one of the UE in the network. In a wireless network, the search of the best path between two node sets is useful, when there exist wired connections among nodes in the same node sets so that communicating with one of the members of a node set is to a large extent equivalent to communicating with any other member in the same node set.

If the network implements centralized routing, the method is, according to one aspect, executed within a node 11 of the multi-hop network. However, it is also possible that the method is executed in a node outside the multi-hop network or in a distributed manner within or outside the network, as will further be described below.

The disclosed method starts with the step of including, S1, in the multi-hop network, a fictitious node. The fictitious node is also referred to as a virtual hub. The fictitious node, 15, is defined to have fictitious links, 151, to at least two of the target nodes, 12, in the multi hop network, see FIG. 3. The fictitious node is fictitious in a sense that such a node does not exist in reality. However, from the perspective of the other nodes in the network the node is seen as a real network node.

At least the neighbour nodes of the fictitious node are typically aware that the fictitious node does not exist, even though the fictitious node is treated it like a real node, when running the routing algorithm. For example, if an aggregation node receives a packet targeting a fictitious node, the aggregation node will realize that the packet is intended for another recipient, typically a final recipient in a communication network 2. In such a case, the address of the fictitious node has merely been temporarily used for routing purposes.

The next step of the method involves determining, S2, at least part of one or more extended routes for connecting one or more of the nodes comprised in the multi-hop network, to the fictitious node. Because this is a routing problem having a defined target node, i.e. the fictitious node, it is now possible to use any existing routing algorithm for determining an optimum path, designed for the case of only a single aggregation node. This is simply done by applying a known routing algorithm between the node being the source node and the fictitious node.

If centralized routing is applied, the device performing route determination typically calculates a complete route from each node to a target node. However, if distributed routing is applied, each node typically only calculates a part of the route between a node and a target. The routing is then done stepwise, through the multi-hop network, where each node calculates a part of the route and forwards the packet.

The third step of the method involves determining, S3, at least a part of a route in the multi-hop network, using the at least part of one or more extended routes. Hence, the extended route determined in step S2 is used when determining a real route from one of the nodes 11 to a destination node within the communication network 2. There are different approaches to this, which will be further described below.

According to one aspect of this disclosure, the step, S1, of defining the fictitious node comprises updating the neighbor lists of the target nodes, to which the fictitious node is defined to be connected, with an identity of the fictitious node. According to one aspect of the disclosure the identity is a predefined IP address or a IMEI number. The identifier may only be defined within the multi-hop network, where the identifier is used. Node-type in combination with the manufacturer's serial number is one possibility. If routing is centralized, the routing device sends an instruction to add a fictitious node, to all target nodes.

According to another aspect, the target nodes by default always add a fictitious node in their neighbor lists. For example, all aggregation nodes, knowing that they have a link to a communication network, such as a core network, automatically insert a fictitious node having a predefined identity in their neighbor lists. A node that wants to send data to the core network can then use the predefined identity for route determination. This variant is also applicable to the decentralized case, as will be further described below.

In general, the considered multi-hop network can be represented by a connected graph having nodes and links interconnecting the nodes, as described above. According to one aspect of this disclosure, the step, S2, of determining at least part of one or more extended routes comprises representing each node comprised in the multi-hop network 10 by a vertex of a graph. Then a routing algorithm is applied for finding the shortest paths from a single vertex to every other destination vertex in a graph, to the graph.

Similarly, according to a further aspect of this disclosure, the step, S2, of determining at least part of one or more extended routes comprises representing each node comprised in the multi-hop network 10 by a vertex of a graph and applying a routing algorithm for finding the shortest paths from a single vertex to a single destination vertex in a graph, to the graph. Examples of routing algorithms are the Dijkstra or Bellman-Ford algorithms.

FIG. 6 further illustrates in a graph, an extended route 110 between a node 11 and a fictitious node 15. According to one aspect of the disclosure, each extended path or route 110 comprises two parts, 151, 111. The first part is “real” path or route 111 for connecting one of the node 11 comprised in the multi-hop network to one of the target nodes 12. In this example the “real” path 111 only comprises one link. The second part is a fictitious link 151 connecting the target node 12 to the fictitious node 15.

According to one aspect of this disclosure, the step of determining, S3, at least a part of a route in the multi-hop network, comprises removing the fictitious link 151, from the extended route 110. Thereby a route 111 for connecting one of the nodes comprised in the multi-hop network, to the communication network, is determined.

According to one aspect of this disclosure, the step of determining, S3, at least a part of a route in the multi-hop network, further comprises identifying, S3b, the target node via which the extended route 110 is routed by analyzing the extended route. As stated above a route comprises a sequence of nodes and links. Each extended route passes via one target node, which can be identified by analyzing the sequence.

In practice this step may consist in the concerned target node making a note (implicitly or explicitly) in its local routing table that a particular route would pass via it. In a multi-hop network, each node basically determines and maintains a routing table with information, for each of a number of destinations, of a preferred next hop node. When a node receives a packet, it forwards the packet to the next hop node on the basis of information on the destination of the packet. The forwarding process continues from node to node until the packet reaches the destination.

According to one aspect of this disclosure, the method for route determination further comprises communicating, S4, routing information to one or more of the nodes comprised in the multi-hop network. When centralized routing is used, a single node (e.g. an aggregation node) is assumed to have access to all relevant (or at least sufficient) information about all relevant (or a sufficient subset of) nodes and links in the network. According to this aspect, routing information is communicated from this node to the concerned nodes in the network.

According to one aspect of this disclosure, the connection between the fictitious node and each target node is defined to have more capacity and less latency than any link in the multi-hop network. More precisely, the connections between the fictitious node and all target nodes are defined to have the same capacity, possibly more than any link in the multi-hop network, and the same latency, possibly less than any link in the multi-hop network. This implies that in principle the capacity and latency of the extended route is the same as the capacity and latency of the route for connecting the corresponding target node to a node in the multi-hop network.

According to a further aspect of this disclosure, the connection between the fictitious node and each target node is defined to have infinite capacity and zero latency. The reason for defining the fictitious links in this way is that the fictitious links should not affect the route determination.

The present disclosure further comprises a method for routing in a multi-hop network, the method comprising the steps of performing route determination, S1-S3, as described above and connecting, S5, a wireless device to the communication network, using the determined route. In practice this simply consists in the nodes in the network starting to use the route determined in Step S2.

### Routing Considering Multiple Metrics

Routing is typically performed by first defining a routing metric, and then searching for the routing solution that optimizes that metric. The routing metric should represent the quantity to be optimized. According to one aspect of this disclosure, the routing metric used for route determination, S2, is bit-rate and/or latency.

Normally, one defines a path metric μ(P) as a real-valued function of one variable, the route P. The best route P={vᵢ}ᵢ₌₁^{K} between a source node v₁ and a destination node v_{K} is then the route that yields the smallest (or largest) path metric μ(P).

A path metric μ(P) can often be expressed as a simple function of the link metric w(l) assigned to each individual link lεE(P) along the route P, with μ(l)≡w(l). Such a function determines how the routing metric μ(P) of a path P relates to those of its sub paths.

For example, the hop-count metric of a path P is simply the total number of links in the path (i.e. μ_{hop-count}(P)=|E(P)|=Σ_{lεE(P)}w_{hop-count}(l), where w_{hop-count}(l)=1), and the latency metric of a path P is simply the sum of the latencies of the individual links (i.e. μ_{latency}(P)=Σ_{lεE(P)}w_{latency} (l)). In this case, the routing metric is an additive metric in the sense that μ(P₁⊕P₂)=μ(P₁)+μ(P₂) for all sub paths P₁ and P₁ of P such that P₁⊕P₂=P.

For another example, the throughput metric of a path P is the minimum (bottleneck) of the link bit rates along the path (i.e. μ_{bitrate}(P)=min_{lεE(P)}w_{bitrate}(l), where w_{bitrate} (l) denotes the data rate supportable by link l). In this case, the routing metric is a minimum metric in the sense that μ(P₁⊕P₂)=min{μ(P₁), μ(P₂)} for all sub paths P₁ and P₂ of P such that P₁⊕P₂=P. Note that equivalently, the throughput of a path P can also be measured by the longest time required to, transfer one bit over any link along the path (i.e. μₜₓ_{_{—}}ₜᵢₘₑ_{_{—}}ₚₑᵣ_{_{—}}_{bit} (P)=max_{lεE(P)}[w_{bitrate}(l)]⁻¹, in which case the routing metric is a maximum metric in the sense that μ(P₁⊕P₂)=max{μ(P₁), μ(P₂)} for all sub paths P₁ and P₂ of P such that P₁⊕P₂=P. However, to avoid confusion, in this application, whenever the throughput of a path is discussed, the use of a minimum metric is intended. However, the presented technique is of course applicable to a maximum metric application.

In the following a few examples of more general routing situations are given, where alternative and more general definitions of routing metrics may be required:

When multiple routes need to be established in the network, e.g. because several users wish to communicate simultaneously, each route may in principle be selected to optimize its respective path metric as defined above. However, since the metric of one route may depend on what other routes exist in the network (e.g. through radio interference in a wireless network), the path metric may in such cases better be expressed as a function of two variables, the path in question as well as the set of other routes present in the network, i.e. the metric for a path Pₙ can be expressed as μ(Pₙ, Q\Pₙ), where Q={P₁, P₂, P₃, . . . , P_{N}} is the set of all routes present in the network and \ denotes set difference. For even more generality, we may consider a case where the router is designed to derive a routing solution that optimizes the overall performance of a network, i.e. it not only optimizes the quality of each route individually, but also considers, e.g., fairness between different users. It may then be better to define instead an overall multi-path metric μ(Q).

Sometimes, there may for each route be multiple metrics that should be jointly optimized according to some quality-of-service (QoS) requirements, e.g. there may be one bit rate metric μ_{bit-rate}(P) and one latency metric μ_{latency} (P), and the target may be to maximize the bit rate under the constraint of keeping the latency below a certain limit. In such cases, it is in principle possible to combine the two metrics into a single joint metric μ_{combined} (P). However, the resulting metric may pose a more difficult routing problem, e.g. it will in general not fulfill the conditions necessary to use the Bellman-Ford or Dijkstra algorithms. In general, finding optimal routes considering multiple metrics is a NP-hard problem i.e. non-deterministic polynomial-time hard in computational complexity theory. One could say that a NP-hard problem is a mathematical problem, for which, even in theory, no shortcut or smart algorithm is possible that would lead to a simple or rapid solution. Instead, the only way to find an optimal solution is a computationally-intensive, exhaustive analysis, in which all or most of the possible outcomes are tested.

If routing needs to consider multiple metrics, one may use a combined real-valued metric μ_{combined}(P). Alternatively, and more generally, one may define vector-valued metric μ̅_{combined}(P), where each vector element represents the value of one of the multiple metrics under consideration. By further generalizing of the symbol ≦ in (9) and (10) denote the ranking (ordering) operator of the routes, the above techniques for a single metric can be directly reused.

Based on the above examples, it should be easy for the person skilled in the art to see how a similar technique can be applied also with other metric definitions.

The presented technique can be generalized and extended in several ways. One extension is the case where the connections from the aggregation nodes to the external network (e.g. to the Internet) do not have infinite capacity and zero latency. The quality of the links from the aggregation nodes to the external network can then be modeled by ascribing, to the links (v, a₁), (a₁, v), (v, a₂), (a₂, v), . . . , (v, a_{M}), (a_{M}, v) in the above description, metric values representing the properties of the respective links.

### Generalized Route

Finally, in practice, the quality of a route often depends not only on its node/link sequence, but also on the allocation of radio resources in each of the links (e.g. in terms of time or frequency slots, beam forming, power control, etc). A multi-route metric can then be seen as a two-argument function μ(Q, A), where A represents the resource allocations in the network. Alternatively, one may introduce the concept of a generalized route \tilde{P}, which is a path in the network with associated resource allocation information for each of its links. For example, each node vᵢ may for each of its links ((vᵢ, vₖ_{₁}), (vᵢ, vₖ_{₂}), . . . ) maintain a table of which radio resources (e.g. time or frequency slots) that are to be used for communication on the respective link, and this information may be considered part of any generalized route \tilde{P} passing through such a link. However, many other ways of associating resource allocation information to routes are possible. For any generalized route \tilde{P}, one may then define a generalized path metric μ(\tilde{P}). Analogously, one may define a generalized metric μ(\tilde{P}ₙ, \tilde{Q}\\tilde{P}ₙ) or a generalized multi-path metric μ(\tilde{Q}), where \tilde{Q}={\tilde{P}₁, \tilde{P}₂, \tilde{P}₃, . . . , \tilde{P}_{N}}, where \tilde{P}ᵢ denotes one of the N generalized route present in the network. Yet another alternative is to transform the original network to an expanded virtual network, in which each node represents a possible way of allocating radio resources (e.g. time and/or frequency slots) to a real network node. This approach is further described in “Interference-Aware Load Balancing for Multihop Wireless Networks”, Y. Yang, J. Wang, and R. Kravets, Tech. Rep. UIUCDCS-R-2005-2526, Department of Computer Science, University of Illinois at Urbana-Champaign, 2005. A route selected in such a virtual network jointly determines a sequence of real network nodes (i.e. the real route) and the corresponding resources allocated to the links associated with these nodes.

We now consider the case where the metric is a function of a generalized route, i.e. μ(\tilde{P}). It is easy to see that the techniques described above directly hold also for this case, by replacing each occurrence of a path (or subpath/link) with the corresponding generalized route. Hence, according to one aspect the present disclosure relates to a method for route determination wherein the route is a generalized route.

Naturally, when using a generalized route to consider resource allocations in the routing decisions, the employed existing routing algorithm for routing between a single well-defined source node and a single well-defined destination node would normally have support for, or at least allow for, consideration of resource allocations in the routing procedure.

### Multiple Routes

We next consider the case where multiple routes are to be established in the network. If the routes do not interact with or depend on each other, the above procedure can be used to establish the routes one by one. If the routes do interact with each other to some extent (e.g. through interference), one possible approach is, as discussed above, to define a path metric μ(P, Q\P). The above procedures for a single route can then be directly applied by replacing each occurrence of a path metric μ(P) with the corresponding path metric μ(P,Q\P). In case a metric of the type μ(Q) is instead used, an analogous procedure can still be used by replacing μ(P) with μ(Q) and μ(P^{(ext)}) with μ(Q^{(ext)}), where Q^{(ext)}={P₁^{(ext)}, P₂^{(ext)}, P₃^{(ext)}, . . . , P_{N}^{(ext)}}. Similar holds for generalized path metrics of the types μ(\tilde{P}ₙ, \tilde{Q}\\tilde{P}ₙ) and μ(\tilde{Q}).

It will be appreciated that the methods described above can be combined and re-arranged in a variety of ways, and that the methods can be performed by one or more suitably programmed or configured digital signal processors and other known electronic circuits, e.g. discrete logic gates interconnected to perform a specialized function, or application-specific integrated circuits.

Many aspects of the proposed technology are described in terms of sequences of actions that can be performed by, for example, elements of a programmable computer system.

Hence, according to one aspect of the present disclosure, it relates to a computer program comprising computer program code which, when executed in a node in a multi-hop network, causes the node to execute the method described above and below.

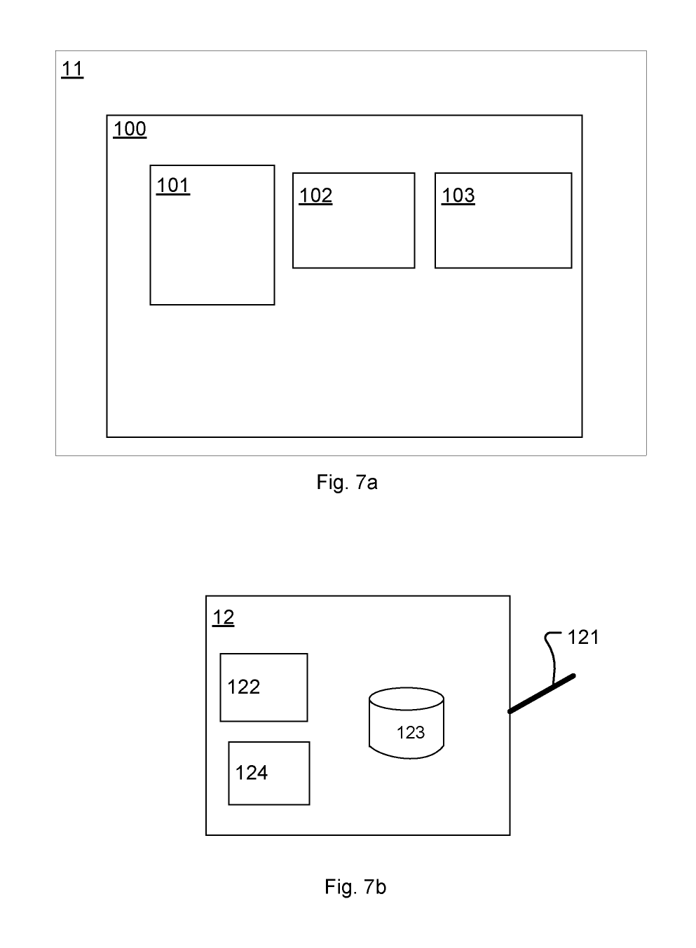

Turning now to FIG. 7a, a schematic diagram illustrating some modules of an exemplary embodiment of a device for route determination in a multi-hop network, comprising at least two target nodes, will be described. The device is configured to manage a representation of the multi-hop network as a connected graph having nodes and links interconnecting said nodes. The device for route determination in a multi-hop network is according to one aspect of this disclosure comprised in a node of the multi-hop network. The device may also be located outside the wireless network.

The device comprises an includer, 101, an extended route determiner, 102, and a route determiner, 103. The includer, 101, is configured to define, in the multi-hop network 10, a fictitious node, 15. The fictitious node is being defined to have connections to at least two of the target nodes. The extended route determiner, 102, is configured to determine at least part of one or more extended routes for connecting one or more of the nodes comprised in the multi-hop network, 10, to the fictitious node 15. The route determiner, 103, is configured to use the at least part of one or more extended route for route determination in the multi-hop network, 10.

The device and the corresponding blocks are further configured to perform the methods for route determination as described in the previous sections.

The device 100 for route determination may be implemented in a network node 11 of a multi-hop network. According to one aspect of the disclosure, the target nodes are aggregation nodes, each aggregation node having a link to a communication network.

According to one aspect of the disclosure it relates to a network node comprising the device, 100, for route determination as described above. The network node 11 includes the routing device 100, but may naturally include other well-known components, e.g. for communication with other network nodes. In general, network nodes pass routing information and maintain their routing tables through the transfer of various routing information messages. The routing information naturally varies depending on the particular routing scheme used. The manner in which the routing tables are determined and updated may also differ from one routing scheme to another.

The steps, functions, procedures and/or blocks described above may be implemented in hardware using any conventional technology, such as discrete circuit or integrated circuit technology, including both general-purpose electronic circuitry and application-specific circuitry.

Alternatively, at least some of the steps, functions, procedures and/or blocks described above may be implemented in software for execution by a suitable computer or processing device such as a microprocessor, Digital Signal Processor (DSP) and/or any suitable programmable logic device such as a Field Programmable Gate Array (FPGA) device and a Programmable Logic Controller (PLC) device.

It should also be understood that it may be possible to re-use the general processing capabilities of any device or unit in which the present technology is implemented, such as a base station, network controller or scheduling node. It may also be possible to re-use existing software, e.g. by reprogramming of the existing software or by adding new software components.

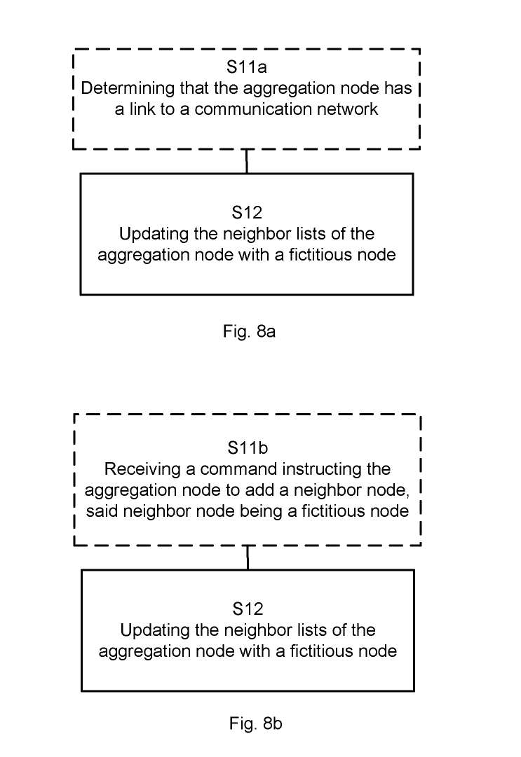

The proposed technology also relates to a method in an aggregation node for attaching a multi-hop network comprising a number of nodes, to a communication network as disclosed in FIGS. 8a and 8b. The method comprises the step of updating, S12, the neighbor list of the aggregation node with the identity of a fictitious node. The neighbor list defines nodes to which the node is connected by direct links. Because the information in all neighbor lists together essentially captures the topological structure characterized by the inter-node connectivity within the network, this step implies that a fictitious node is added to the network.

According to one aspect of the disclosure, illustrated in FIG. 8a, this step is performed automatically by each aggregation node. Hence, the respective aggregation node will determine, S11a, that the node has a link, 121, to a communication network, 2, and then without further instruction, update, S12, the neighbor list of the aggregation node, 12, with a fictitious node, 15, based on the detection of a link, 121, to a communication network. As stated above, the neighbor of any one of the nodes 11 is defining nodes 11, 12, to which that node is connected by direct links.

According to another aspect of the disclosure, illustrated in FIG. 8b, the aggregation node receives, S11b, a command instructing the aggregation node to add a neighbor node being a fictitious node. The command may be sent from a device performing centralized route determination in the multi-hop network.

According to another aspect of the disclosure, the fictitious node is assigned a predefined identifier, such as an IP address. Predefined implies that the identifier is preprogrammed in the network nodes. At least the network nodes need to know the identifier before route determination is started. This is advantageous, because the fictitious node can then be added without informing the other nodes in the network. A node that wants to send data to the communication network can then use the predefined identity or address for routing.

According to another aspect of the disclosure, illustrated in FIG. 7b, it relates to an aggregation node, 12, for attaching a multi-hop network, 10, comprising a number of nodes, 11, to a communication network, 2. The aggregation node 12 may be implemented as an Evolved Node B (eNB or eNodeB) in LTE or present or future communication system. The aggregation node, 12, comprises a link, 121, to the communication network, a communication interface (i/f), 122, a memory, 123 and processing circuitry, 124.

The link, 121, is either wired or wireless. In both cases, the link enables a direct connection between the communication network, 2, and the aggregation node, 12.

The communication interface (i/f), 122, is arranged for wireless communication with the other nodes, 11, in the multi-hop network.

The memory 123 can be any combination of a Read And write Memory, RAM, and a Read Only Memory, ROM. The memory 123 may also comprise persistent storage, which, for example, can be any single one or combination of magnetic memory, optical memory, or solid state memory or even remotely mounted memory. The memory, 123, is configured to store a neighbor list defining the nodes 11, 12 in the multi-hop network, to which the aggregation node, 12, is connected by direct links.

The processing circuitry or controller or processor 124 may be constituted by any suitable Central Processing Unit, CPU, microcontroller, Digital Signal Processor, DSP, etc. The processing circuitry may be capable of executing computer program code. According to one aspect of the disclosure, the computer program code is stored in a memory. The processing circuitry is configured to update the neighbor list in the memory, 123, of the aggregation node, 11, with a fictitious node, 15. According to one aspect of the disclosure, this is done when the above-mentioned computer program code is executed in the processing circuitry 124 of the aggregation node. Hence, one aspect of the present disclosure, it relates to a computer program comprising computer program code which, when executed in an aggregation node in a multi-hop network, causes the node to execute the method described above.

According to one aspect of the present disclosure, the aggregation node 12 is comprised in a wireless backhaul, 10, connecting at least one wireless access point, 11, to a communication network, 2. The aggregation node is then e.g. a base station in present or future communication systems.

1. A method for route determination in a multi-hop network comprising a number of nodes, whereof at least two nodes are target nodes, the method comprising:
including in the multi-hop network, a fictitious node, the fictitious node being defined to have fictitious links to at least two of the target nodes,
determining at least part of one or more extended routes for connecting one or more of the nodes comprised in the multi-hop network, to the fictitious node and
determining at least a part of a route in the multi-hop network, using the at least part of one or more extended routes.

2. The method for route determination according to claim 1, wherein the target nodes are aggregation nodes, each aggregation node having a link to a communication network.

3. The method for route determination according to claim 1, wherein the defining the fictitious node comprises updating neighbor lists of the target nodes, to which the fictitious node is defined to be connected, with an identity of the fictitious node.

4. The method for route determination according to claim 1, wherein the determining at least part of one or more extended routes comprises:
representing each node comprised in the multi-hop network by a vertex of a graph; and
applying to said graph, a routing algorithm for finding the shortest paths from a single vertex to one other or to every other, destination vertex in a graph.

5. The method for route determination according to claim 1, wherein a routing metric used for route determination is bit-rate and/or latency.

6. The method for route determination according to claim 1, wherein each extended route comprises a route for connecting one of the nodes comprised in the multi-hop network to one of the target nodes and a fictitious link connecting the target node to the fictitious node.

7. The method for route determination according to according to claim 1, wherein the determining at least a part of a route in the multi-hop network, further comprises:
removing the fictitious link, from the extended route, whereby a route for connecting one of the nodes comprised in the multi-hop network, to the communication network, is determined.

8. The method for route determination according to claim 1, wherein the determining at least a part of a route in the multi-hop network, further comprises:
identifying the target node via which the extended route is routed by analyzing the extended route.

9. The method for route determination according to claim 1, further comprising:
communicating routing information to one or more of the nodes comprised in the multi-hop network.

10. The method for route determination according to claim 1, wherein the multi-hop network is a wireless backhaul and the at least one node is at least one wireless mobile entity or access point that is to be connected to the communication network.

11. The method for route determination according to claim 1, wherein the method is executed in one of the nodes comprised in the multi-hop network.

12. The method for route determination according to claim 1, wherein the connection between the fictitious node and each target node, is defined to have more capacity and less latency than any link in the multi-hop network.

13. The method for route determination according to claim 1, wherein the connection between the fictitious node and each target node, is defined to have infinite capacity and zero latency.

14. A computer program product comprising a non-transitory computer readable storage medium storing program code which, when executed in a node in a multi-hop network, causes the node to execute the method claimed in claim 1.

15. A method for routing in a multi-hop network, the method comprising:
performing route determination according to claim 1; and
connecting a wireless device to the communication network, using the determined route.

16. A device for route determination in a multi-hop network, comprising at least two target nodes, the device comprising:
an includer configured to define, in the multi-hop network, a fictitious node, the fictitious node being defined to have connections to at least two of the target nodes,
an extended route determiner, configured to determine at least part of one or more extended routes for connecting one or more of the nodes comprised in the multi-hop to the fictitious node, and
a route determiner configured to use the at least part of one or more extended routes, for route determination in the multi-hop network.

17. The device for route determination according to claim 16, wherein the target nodes are aggregation nodes, each aggregation node having a link to a communication network.

18. A network node comprising a device for route determination according to claim 16.

19. A method in an aggregation node, the aggregation node attaching a multi-hop network comprising a number of nodes to a communication network, comprising:
updating a neighbor list of the aggregation node with an identity of a fictitious node, said neighbor list defining nodes to which the aggregation node is connected by direct links.

20. The method in an aggregation node according to claim 19 further comprising:
determining that the aggregation node has a link to a communication network;
wherein the updating the neighbor list of the aggregation node with a fictitious node, further comprises, updating the neighbor list of the aggregation node with an identity of a fictitious node, based on the detection of a link to a communication network.

21. The method in an aggregation node according to claim 19 further comprising:
receiving a command instructing the aggregation node to add a neighbor node, said neighbor node being a fictitious node.

22. The method in an aggregation node according to claim 19, wherein the fictitious node is assigned a predefined identifier.

23. The method in an aggregation node according to claim 19, wherein the aggregation node is a node in a wireless backhaul connecting at least one wireless access point to the communication network.

24. An aggregation node, for attaching a multi-hop network comprising a number of nodes to a communication network, comprising:
a link to the communication network;
a communication interface configured for wireless communication with the nodes in the multi-hop network;
a memory configured to store a neighbor list defining the nodes in the multi-hop network, to which the aggregation node is attached; and
processing circuitry, configured to update the neighbor list of the aggregation node with a fictitious node.

25. An aggregation node according to claim 24, wherein the aggregation node is comprised in a wireless backhaul connecting at least one wireless access point to a communication network.
